(19) United States
(12) Patent Application Publication
(10) Pub. No.: US 2015/0185817 A1
(43) Pub. Date: Jul. 2, 2015

(54) CHARGING CIRCUIT FOR USB INTERFACE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: JIE MIN, Wuhan (CN); CHUN-SHENG CHEN, New Taipei (TW)

(21) Appl. No.: 14/523,118

(22) Filed: Oct. 24, 2014

(30) Foreign Application Priority Data
Dec. 30, 2013 (CN) 201310742318.2

(51) Int. Cl. G06F 1/32

(52) U.S. Cl. CPC G06F 1/3287

(57) ABSTRACT

A charging circuit for USB interface includes a power supply unit, a USB interface, a control module with a current limiting terminal, and a transformation module connected to the current limiting terminal. The control module is connected between the power supply unit and USB interface. The transformation module is configured to generate a first control electric current or a different second control electric current through the current limiting terminal. When the first control electric current flows through the current limiting terminal, a first output electric current is inputted to the USB interface. When the second control electric current flows through the current limiting terminal, a different second output electric current is inputted to the USB interface, in either case data can be transmitted in parallel with the electrical power.

### FIELD

The subject matter herein generally relates to power transmission circuits.

### BACKGROUND

USB (Universal Serial Bus) interface is widely used in variety of electronic devices, such as computers, for coupling to smart phones and digital cameras. These external electronic devices can be charged by a computer with USB interface via a USB cable.

### BRIEF DESCRIPTION OF THE DRAWINGS

Implementations of the present technology will now be described, by way of example only, with reference to the attached figures.

FIG. 1 is a diagrammatic view of the charging circuit of an embodiment.

FIG. 2 is a detail view of the circuit connection of the charging circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

The present disclosure is described in relation to a charging circuit for USB interface. The charging circuit for USB interface includes a power supply unit, a USB interface, a control module with a current limiting terminal, and a transformation module connected to the current limiting terminal. The control module is connected between the power supply unit and USB interface. The transformation module is configured to generate a first control electric current or a second control electric current either of which flows through the current limiting terminal. When the first control electric current flows through the current limiting terminal, a first output electric current flows to the USB interface. When the second control electric current flows through the current limiting terminal, a second output electric current flows to the USB interface.

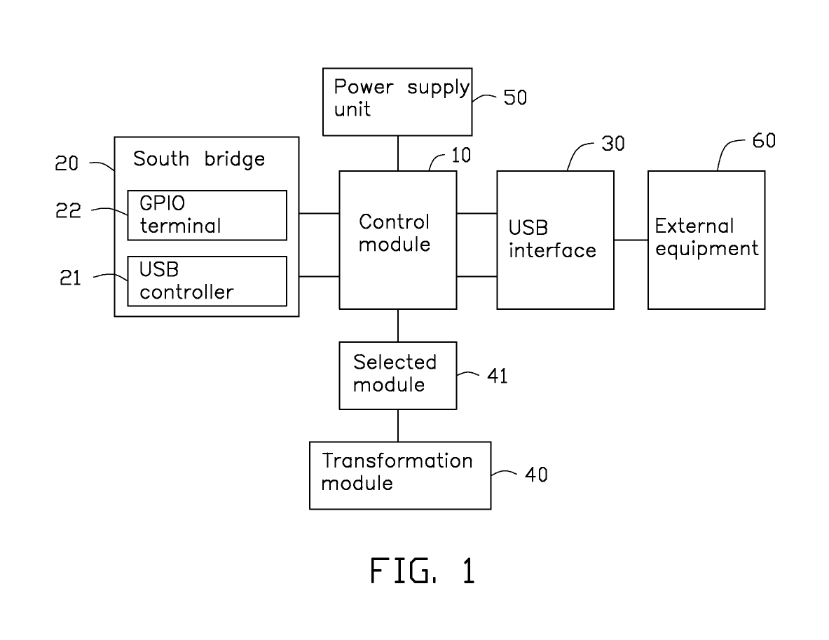

FIG. 1 illustrates an embodiment of a charging circuit for USB interface. The charging circuit for USB interface includes a control module 10, a south bridge 20, a USB interface 30, a transformation module 40, a selection module 41, and a power supply unit 50. The control module 10 is connected between the power supply unit 50 and the USB interface 30. A variety of independent electronic devices (external equipment 60), such as a smart phone or a digital camera, can be connected to the USB interface 30 for charging.

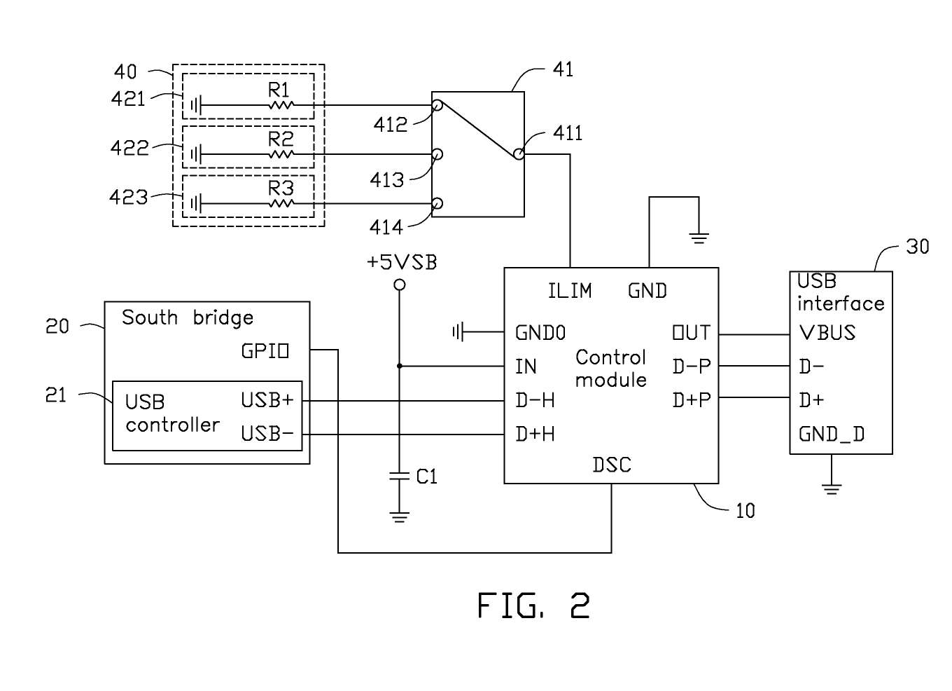

The south bridge 20 is capable of transmitting a first signal to switch on the control module 10, or a second signal to switch off the control module 10. In at least one embodiment, the first signal is a high level signal, and the second signal is a low level signal. A General-Purpose Input/Output (GPIO) terminal 22 (shown in FIG. 2 as the GPIO pin) of the south bridge 20 is connected to an enable terminal (shown in FIG. 2 as the DSC pin) of the control module 10 for transmitting the first signal or the second signal. An output electric current is able to flow to the USB interface 30 only when the control module 10 is switched on.

The south bridge 20 further includes a USB controller 21, which is connected to the USB interface 30 via the control module 10, to transmit USB data.

The transformation module 40 is connected to the control module 10 and configured to generate one of at least two different control electric currents. The transformation module 40 is connected to a current limiting terminal (shown in FIG. 2 as ILIM pin) of the control module 10 via the selection module 41. Thereby one of the at least two different control electric currents is enabled to flow through the current limiting terminal. When one of the at least two different control electric currents flows through the current limiting terminal, one of at least two different output electric currents flows to the USB interface 30.

FIG. 2 illustrates that, in an embodiment, the south bridge 20 is a Platform Controller Hub (PCH), the control module 10 is an integrated circuit chip controlled by electric current, and the selection module 41 is a single pole three-throw switch. The transformation module 40 has a first transformation circuit 421, a second transformation circuit 422, and a third transformation circuit 423. According to actual requirements for quantity of output electric currents, the selection module 41 can be other single pole multi-throw switch, and the transformation module 40 can have the necessary quantity of transformation circuits.

The GPIO pin of the south bridge 20 is connected to a DSC pin of the control module 10 for transmitting the first signal or the second signal. The power supply unit 50 is connected to an IN pin of the control module 10 to power up the control module 10. In at least one embodiment, the power supply unit 50 outputs a positive voltage of 5 volts.

The charging circuit for USB interface further includes a polarized capacitor C1 for smoothing. A positive pole of the polarized capacitor C1 is connected to the IN pin of the control module 10 and the power supply unit 50, and a negative pole of the polarized capacitor C1 is grounded. In at least one embodiment, the capacitance value of the polarized capacitor C1 is 0.1 μF.

A fixed end 411 of the selection module 41 is connected to a ILIM pin of the control module 10, a first selected end 412 is connected to the first transformation circuit 421, a second selected end 413 is connected to the second transformation circuit 422, and a third selected end 414 is connected to the third transformation circuit 423. Thereby the control module 10 is capable of connecting to the first transformation circuit 421, to the second transformation circuit 422, or to the third transformation circuit 423 via the selection module 41.

The first transformation circuit 421 includes a first resistor R1, the second transformation circuit 422 includes a second resistor R2, and the third transformation circuit 423 includes a third resistor R3. The first resistor R1, the second resistor R2, and the third resistor R3 have different resistance values. In at least one embodiment, the resistance value of the first resistor R1 is 20 KΩ the resistance value of the second resistor R2 is 40 KΩ and the resistance value of the third resistor R3 is 80 KΩ.

When the control module 10 is connected to the first transformation circuit 421 which has the first resistor R1, a first control electric current flows through the ILIM pin of the control module 10. When the control module 10 is connected to the second transformation circuit 422 which has the second resistor R2, a second control electric current flows through the ILIM pin of the control module 10. When the control module 10 is connected to the third transformation circuit 423 which has the third resistor R3, a third control electric current flows through the ILIM pin of the control module 10. The levels of current of the first control electric current, the second control electric current, and the third control electric current are different.

When the first control electric current flows through the ILIM pin of the control module 10, a first output electric current flows to the USB interface 30 via the control module 10. When the second control electric current flows through the ILIM pin of the control module 10, a second output electric current flows to the USB interface 30 via the control module 10. When the third control electric current flows through the ILIM pin of the control module 10, a third output electric current flows to the USB interface 30 via the control module 10. The levels of current of the first output electric current, the second output electric current, and the third output electric current are different.

An OUT pin of the control module 10 is connected to a VBUS pin of the USB interface 30 to transport the first output electric current, the second output electric current, and the third output electric current.

A USB+ pin of the USB controller 21 is connected to a D+H pin of the control module 10, and a USB− pin of the USB controller 21 is connected to a D−H pin of the control module 10. A D+ pin of the USB interface 30 is connected to a D+P pin of the control module 10, and a D− pin of the USB interface 30 is connected to a D−P pin of the control module 10. Thereby data can be transmitted between the USB controller 21 and the USB interface 30.

Each of a GND pin and a GNDO pin of the control module 10, and a GND _D pin of the USB interface 30 are grounded.

In operation, when external equipment 60 such as a smart phone is connected to the USB interface 30, the south bridge 20 transmits a high level signal to switch on the control module 10, and the control module 10 is connected to the first transformation circuit 421 via the selection module 41. The charging circuit outputs the first output electric current to charge the smart phone. When external equipment 60 such as a tablet computer is connected to the USB interface 30, the south bridge 20 transmits a high level signal to switch on the control module 10, and the control module 10 is connected to the second transformation circuit 422 via the selection module 41. The charging circuit outputs the second output electric current to charge the tablet computer.

Simultaneously, the data can be outputted to the external equipment 60 in parallel with the output electric current.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A charging circuit for USB interface comprising:
a power supply unit and a USB interface;
a control module, connected between the power supply unit and the USB interface;
a transformation module, having a first transformation circuit and a second transformation circuit; and
a selection module, connected between the control module and the transformation module, wherein, the selection module is enabled to connect the control module to either the first transformation circuit or the second transformation circuit;
wherein, when the control module is connected to the first transformation circuit, a first output electric current flows to the USB interface; and when the control module is connected to the second transformation circuit, a different second output electric current flows to the USB interface.

2. The charging circuit for USB interface of claim 1, further comprising a south bridge connecting to the control module; wherein, the control module is switched on or switched off by the south bridge.

3. The charging circuit for USB interface of claim 2, wherein the south bridge is able to transmit a first signal to switch on the control module, or a different second signal to switch off the control module.

4. The charging circuit for USB interface of claim 3, wherein a General-Purpose Input/Output (GPIO) terminal of the south bridge is connected to an enable terminal of the control module for transmitting the first signal or the second signal.

5. The charging circuit for USB interface of claim 1, wherein the selection module is a single pole multi-throw switch, a fixed end of the selection module is connected to the control module, and each selected end of the selection module is connected to each of the first transformation circuit and the second transformation circuit.

6. The charging circuit for USB interface of claim 1, wherein when the control module is connected to the first transformation circuit, a first control electric current flows through the control module; and when the control module is connected to the second transformation circuit, a different second control electric current flows through the control module.

7. The charging circuit for USB interface of claim 6, wherein the control module has a current limiting terminal connected to the selection module; when the control module is connected to the transformation module, the first control electric current or the second control electric current flows through the current limiting terminal.

8. The charging circuit for USB interface of claim 1, wherein the first transformation circuit comprises a first resistor, the second transformation circuit comprises a second resistor; the first resistor and second resistor have different resistance values.

9. The charging circuit for USB interface of claim 1, further comprising a polarized capacitor for smoothing, a positive pole of the polarized capacitor connected to the control module, and a negative pole of the polarized capacitor grounded.

10. The charging circuit for USB interface of claim 9, wherein the power supply unit is connected to the positive pole of the polarized capacitor.

11. A charging circuit for USB interface comprising:
a power supply unit and a USB interface;
a control module with a current limiting terminal, connected between the power supply unit and the USB interface; and
a transformation module connected to the current limiting terminal, configured to generate a first control electric current or a different second control electric current flowing through the current limiting terminal;
wherein, when the first control electric current flows through the current limiting terminal, a first output electric current flows to the USB interface; and when the second control electric current flows through the current limiting terminal, a different second output electric current flows to the USB interface.

12. The charging circuit for USB interface of claim 11, further comprising a selection module;
wherein, the transformation module has a first transformation circuit and a second transformation circuit, the selection module is enable to connect the control module to either the first transformation circuit or the second transformation circuit.

13. The charging circuit for USB interface of claim 12, wherein when the control module is connected to the first transformation circuit, the first control electric current flows through the current limiting terminal; and when the control module is connected to the second transformation circuit, the second control electric current flows through the current limiting terminal.

14. The charging circuit for USB interface of claim 12, wherein the selection module is a single pole multi-throw switch, a fixed end of the selection module is connected to the current limiting terminal, and each selected end of the selection module is connected to each of the first transformation circuit and second transformation circuit.

15. The charging circuit for USB interface of claim 12, wherein the first transformation circuit comprises a first resistor, the second transformation circuit comprises a second resistor; the first resistor and the second resistor have different resistance values.

16. The charging circuit for USB interface of claim 11, further comprising a south bridge connecting to the control module; wherein, the control module is switched on or switched off by the south bridge.

17. The charging circuit for USB interface of claim 16, wherein the first output electric current or the second output electric current is able to be inputted to the USB interface when the control module is switched on.

18. The charging circuit for USB interface of claim 11, further comprising a polarized capacitor for smoothing, a positive pole of the polarized capacitor connected to the control module, and a negative pole of the polarized capacitor grounded.

19. The charging circuit for USB interface of claim 18, wherein the power supply unit is connected to the positive pole of the polarized capacitor.

20. The charging circuit for USB interface of claim 11, wherein the control module is an integrated circuit chip.
